(19) United States
(12) Patent Application Publication
(10) Pub. No.: US 2018/0323550 A1
(43) Pub. Date: Nov. 8, 2018

(54) SINGLE-PAIR ETHERNET PLUG

(71) Applicant: Sentinel Connector Systems, Inc., York, PA (US)

(72) Inventors: Robert Brennan, York, PA (US); Justin Wagner, York, PA (US)

(21) Appl. No.: 15/941,223

(22) Filed: Mar. 30, 2018

Related U.S. Application Data
(60) Provisional application No. 62/479,833, filed on Mar. 31, 2017.
(60) Provisional application No. 62/517,417, filed on Jun. 9, 2017.

(51) Int. Cl. H01R 13/6594; H01R 24/64

(52) U.S. Cl. CPC H01R 13/6594; H01R 2201/04; H01R 24/64

(57) ABSTRACT

A modular plug including a housing having a single-pair of contacts for Ethernet data and power. Each contact includes a conductor termination portion disposed at the channel and a jack interface portion disposed at the mating end. The conductor termination portion has a width greater than a width of the jack interface portion.

### CROSS-REFERENCE TO RELATED APPLICATIONS

This application claims the benefit of and priority from U.S. Application Ser. No. 62/479,833, filed Mar. 31, 2017 and U.S. Application Ser. No. 62/517,417, filed Jun. 9, 2017, both of which are hereby fully incorporated herein by reference.

### BACKGROUND OF THE DISCLOSURE

The present disclosure generally relates to modular plugs. More particularly, the present disclosure relates to modular plugs with a pair of wires for Ethernet connectivity, data bandwidth and power delivery.

### BRIEF DESCRIPTION OF THE SEVERAL VIEWS OF THE DRAWING(S)

The following detailed description of the disclosure, is better understood when read in conjunction with the appended drawings. For the purpose of illustrating the disclosure, exemplary constructions of the inventive concepts of the disclosure are shown in the drawings. However, the disclosure, drawings and the inventive concepts disclosed herein are not limited to the specific structure, function, methods and instrumentalities disclosed herein.

FIG. 1 exemplarily illustrates a cable end view of a single-pair plug in accordance with an embodiment of the present disclosure.

FIG. 2 exemplarily illustrates a cable end view of a single-pair plug in accordance with another embodiment of the present disclosure.

FIG. 3 exemplarily illustrates a cable end view of a two pair plug in accordance with an embodiment of the present disclosure.

FIG. 4 exemplarily illustrates a perspective view of the plug of FIG. 1, 2 or 3 in accordance with an embodiment of the present disclosure.

FIG. 5 exemplarily illustrates a partially exploded view of the plug of FIG. 4.

FIG. 6 exemplarily illustrates an elevation view of the plug of FIG. 4.

FIG. 7 exemplarily illustrates an exploded view of the plug of FIG. 4.

FIG. 8 exemplarily illustrates a perspective view of a pair of contacts in accordance with an embodiment of the present disclosure.

### DETAILED DESCRIPTION OF THE DISCLOSURE

The following disclosure as a whole may be best understood by reference to the provided detailed description when read in conjunction with the accompanying drawings, drawing description, abstract, background, field of the disclosure, and associated headings. Identical reference numerals when found on different figures identify the same elements or a functionally equivalent element. The elements listed in the abstract are not referenced but nevertheless refer by association to the elements of the detailed description and associated disclosure.

For years, Ethernet cabling used four twisted pairs of conductor wires (most commonly, unshielded twisted pair (UTP) wires) bundled into a cable where the conductor wires are terminated to plugs and jacks having an industry standard type RJ45 configuration and mating interface in order to carry data with limited noise, cross-talk, etc.

However, standards have also been developed that use Ethernet cables not only to carry data, but also to supply Power over Ethernet (PoE) for powered devices (PD). The Institute of Electrical and Electronics Engineers (IEEE) established and continue to establish various standards for PoE, namely, IEEE 802.3 and more specifically 802.3af, 802.3at, 802.3bt, etc. The IEEE standards provide for signaling between the power sourcing equipment (“PSE”) and the PD.

A PSE is a device such as a network switch that provides (or sources) power in common mode over two or more of the differential pairs of wires found in the Ethernet cable. A PD is a device powered by a PSE and thus consumes energy. Examples include wireless access points, Internet Protocol phones and cameras, wireless access points, etc.

The maximum continuous output power a PSE can sink per Ethernet cable was originally the 802.3af PoE standard with −13 W that would be available at the PD input's RJ-45. Since then, the market has continued to demand more power. So, in 2009, the IEEE standard was revised and released IEEE 802.3at (also known as PoE+), which increased the maximum PD power level to 25.5 W. Currently, the IEEE 802.3bt (also known as PoE++ or 4PPoE), will provide PDs with up to 71 W of power (Type 3) or up to 90-100 W (Type 4), where each twisted pair will need to handle a current of up to 600 mA (Type 3) or 960 mA (Type 4). With more power, developers can easily add more features and upgrade existing products. It is conceivable that the current maximum PSE power outputs will continue to rise (for example, 60V at 2 A (120 W) has been proposed) as further developments are made related to PoE.

Unfortunately, standard four pair Ethernet cables include eight conductor wires sized either 24 AWG or 23 AWG, in some circumstances, which have a maximum current supply capability limited to approximately 1.5 amps. Conductor wire size is limited by the physical envelope or dimensions of the RJ45 plug and mating interface. One of skill in the art will recognize that larger conductor wires will enable a higher current capability ceiling, but that the volume of a plug that conforms to the RJ45 standard prevents the use of larger conductor wires. Accordingly, there is a need for a plug that can carry data at desired rates and can supply current in excess of 2 amps.

Recently, standards are being developed under the IEEE 802.3 (Ethernet Working Group) and TIA TR-42 (Telecommunications Cabling Systems Engineering Committee) that feature a single balanced twisted-pair Ethernet cabling. One such developing standard, ANSI/TIA-568.5, is directed to cable, connector, cord, link and channel specifications for single-pair connectivity in enterprise networks for Internet of Things (IoT) applications, which is an outgrowth of the PoE developments. The goals of the standard specified system includes the ability to deliver data at speeds of up to 1G, and PoE power, as mentioned herein, with 100 meters reach. This makes sense because of the growing number of devices connected to networks. At least one estimate reports that there will be nearly 28 billion connected devices in place globally by 2021 and more than half of these will be related to IoT.

For example, most of the devices used in digital buildings, such as sensors, actuators, etc., have power and bandwidth requirements, such as applications for building automation and alarm systems. In these cases, single-pair Ethernet cable can provide a cost-effective cabling solution. The cable is smaller and lighter than a standard four-pair Ethernet cable, so it can also reduce pathway congestion.

Other examples of single-pair Ethernet cable applications, in addition to data centers, digital buildings, enterprise networks or IoT, include automotive and industrial applications.

Connected smart cars require data transmission, at rates similar to IoT, and power supply to do things like park automatically, warn of lane departures and blind spots, provide Internet access and support smartphone apps. A car's networking system, especially for autonomous, semi-autonomous or driverless cars, needs to be able to connect the sensor, actuator, microcontroller units that provide these and other features. A single-pair Ethernet standard is being developed to allow multiple in-vehicle systems (i.e., sensors, actuators, etc.) to supply power with a single-twisted-pair cable that can carry data up to 15 meters.

Industrial applications also use sensors and actuators similar to those used in automotive applications. The data rate requirements are not as high (up to approximately 10 Mbps), but they need to be connected to communicate about production, equipment conditions, the manufacturing environment, etc. from sensing devices that are deployed throughout a facility and to actuate devices in response thereto. Single-pair Ethernet can save money in these environments by allowing cables to be reused, converging existing systems onto Ethernet networks, and making end nodes easier to replace. It also reduces cable weight and size, making the best possible use of space and speeding up installation. The reach under currently proposed standards is up to 40 meters or up to 1 kilometer.

Therefore, there is a need for a standards compliant single-pair Ethernet cable termination plug that can carry data at desired rates and distances, and can supply current in excess of 2 amps.

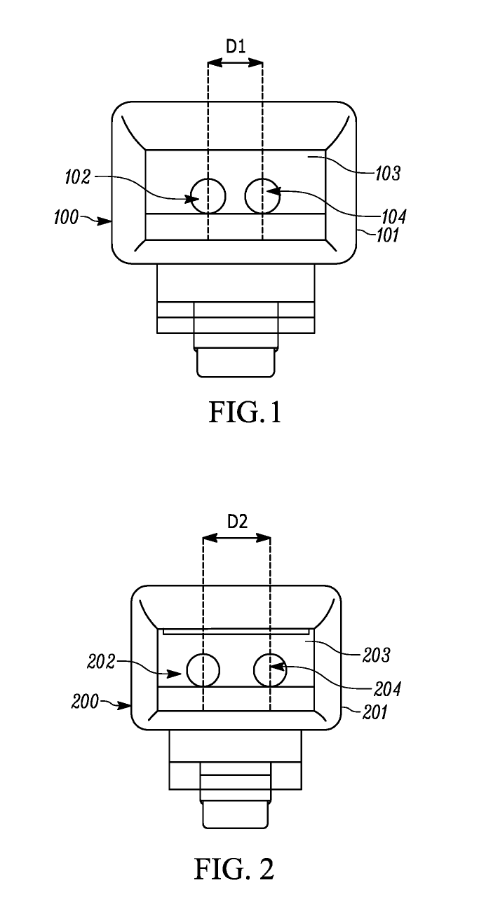

FIG. 1 exemplarily illustrates a cable end view of a single-pair plug 100 in accordance with an embodiment of the present disclosure. The modular plug 100 includes a plug housing 101 with a stuffer cap 103 disposed in a channel of the plug housing 101 and connected thereto. The stuffer cap 103 includes a first channel 102 and a second channel 104, each extending into the stuffer cap 103. The channels 102, 104 may extend partially into or wholly through the stuffer cap 103 as desired by the particular configuration and intended application. In one embodiment, the channels 102, 104 may be separated from the center of an adjacent channel by a distance D1. Preferably, the distance D1 is approximately 0.040 inches for conductor wires that have a size of between 23 AWG and 28 AWG. In one embodiment, D1 may be configured to facilitate contact placement on pins 4 and 5 as one of skill in the art would understand with respect to RJ45 standard interface specifications. Each channel 102 and 104 has an inner diameter that is configured to accommodate an insulated conductor wire having a size of between 23 AWG and 28 AWG. It is within the teachings of the present disclosure that D1 may be larger or smaller and the associated conductor wire size may be larger or smaller in order to provide structure in order to facilitate the intended functionality. A conductor wire (not shown) is inserted into each channel 102 and 104 and terminated as described herein to provide an electrical path for data and current to flow to contacts (not shown) located on an opposite mating end of the plug 100.

FIG. 2 exemplarily illustrates a cable end view of another a single-pair plug 200 in accordance with an embodiment of the present disclosure. The modular plug 200 includes a plug housing 201 with a stuffer cap 203 disposed in a channel of the plug housing 201 and connected thereto. The stuffer cap 203 includes a first channel 202 and a second channel 204, each extending into the stuffer cap 203. The channels 202, 204 may extend partially into or wholly through the stuffer cap 203 as desired by the particular configuration and intended application. In one embodiment, the channels 202, 204 may be separated from the center of an adjacent channel by a distance D2. Preferably, the distance D2 is approximately 0.120 inches for conductor wires have a size of between 16 AWG and 28 AWG. In one embodiment, D2 may be configured to facilitate contact placement on pins 3 and 6 as one of skill in the art would understand with respect to RJ45 standard interface specifications. Each channel 202 and 204 has an inner diameter that is configured to accommodate an insulated conductor wire having a size of between 16 AWG and 24 AWG. It is within the teachings of the present disclosure that D2 may be larger or smaller and the associated conductor wire size may be larger or smaller in order to provide structure in order to facilitate the intended functionality. A conductor wire (not shown) is inserted into each channel 202 and 204 and terminated as described herein to provide an electrical path for data and current to flow to contacts (not shown) located on an opposite mating end of the plug 200.

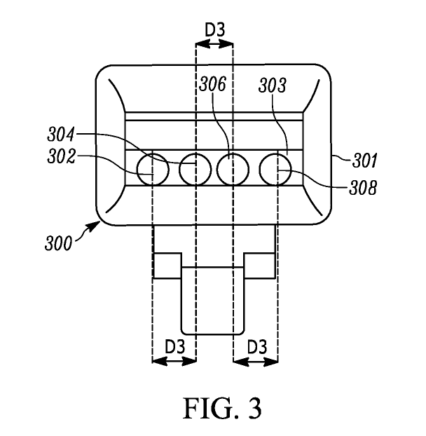

FIG. 3 exemplarily illustrates a cable end view of a two pair plug in accordance with an embodiment of the present disclosure. The modular plug 300 includes a plug housing 301 with a stuffer cap 303 disposed in a channel of the plug housing 301 and connected thereto. The stuffer cap 303 includes a first channel 302, a second channel 304, a third channel 306, and a fourth channel 308, each extending into the stuffer cap 303. The channels 302, 304, 306, 308 may extend partially into or wholly through the stuffer cap 303 as desired by the particular configuration and intended application. In one embodiment, the channels 302, 304, 306, 308 may be separated from the center of an adjacent channel by a distance D3. Preferably, the distance D3 is approximately 0.040 inches for conductor wires have a size of between 22 AWG and 28 AWG. Each channel 302, 304, 306, 308 has an inner diameter that is configured to accommodate an insulated conductor wire having a size of between 22 AWG and 28 AWG. It is within the teachings of the present disclosure that D3 may be larger or smaller and the associated conductor wire size may be larger or smaller in order to provide structure in order to facilitate the intended functionality. A conductor wire (not shown) is inserted into each channel 302, 304, 306, 308 and terminated as described herein to provide an electrical path for data and current to flow to contacts (not shown) located on an opposite mating end of the plug 300.

In one embodiment, the plug 300 may include channels 302, 304, 306, 308 that are grouped such that there is a first set of channels and a second set of channels in various different configurations in order to achieve the intended functionality. For example, the channels of each set may be disposed such that they are not adjacent to the other channel of the same set. Also, the channels of one set may be adjacently disposed with the channels of the other set not adjacently disposed. Additionally, the channels of the first set are configured differently than the channels of the second set, such as, by different size, inner dimension, shape, length, etc. Further, the channels of the first and second sets may be configured similarly in only one aspect. Moreover, the channels of the first and second sets may be all configured similarly.

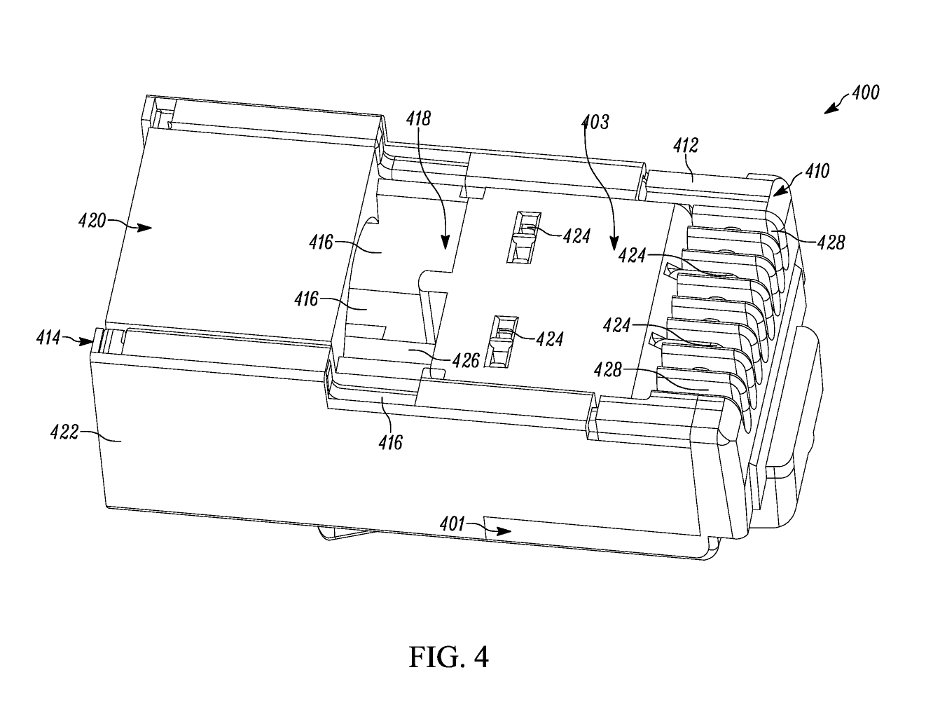

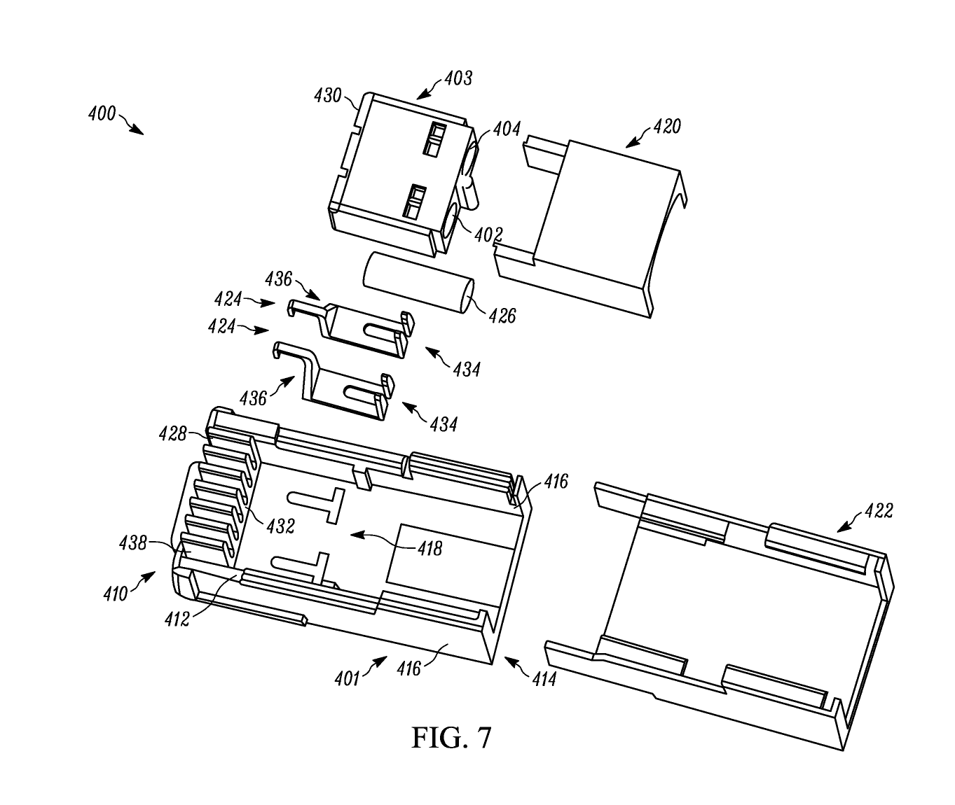

FIG. 4 exemplarily illustrates a perspective view of the plug of FIG. 1, 2 or 3 in accordance with an embodiment of the present disclosure. FIG. 7 exemplarily illustrates an exploded view of the plug of FIG. 4. The modular plug 400 may include a plug housing 401, a stuffer cap 403, a cable holder 420, a shield 422 and a single-pair of contacts 424. A cable (not shown) includes a pair of conductor wires 426 (only one of which is shown for clarity) within an outer sheath, as is commonly understood by one of skill in the art.

The plug housing 401 has a mating end 410 and a cable end 414. The mating end 410 includes an end wall 412 that may have a plurality or two or more slots 428 formed or defined therein. The plug housing 401 also includes a plurality of side walls 416 that extend between the mating end 410 and the cable end 414 to define an open topped channel 418 extending between the end wall 412 and the cable end 414.

The stuffer cap 403 is removably connected to the plug housing 401 within the channel 418 in any conventional manner, such as, snap-fit, bonding, mechanical fastener, etc. In one embodiment, the stuffer cap 403 may be disposed contiguous with the mating end 410. For example, an outer surface 430 (see FIG. 7) of the stuffer cap 403 may contact or engage an interior surface 432 (see FIG. 7) of the end wall 412 when the stuffer cap 403 is moved into connection with the channel 418. The cable holder 420 is removably connected to the plug housing 401 disposed adjacent the stuffer cap 403 and the cable end 414. The cable holder 420 has a groove to accommodate the cable therethrough so as to capture the cable between the side wall 416 (that forms what is referred to as the bottom or base of the channel 418) and the cable holder 420 in a manner to act as a strain relief. A recess may be formed in the bottom or base of the channel 418 to additionally facilitate strain relief functionality.

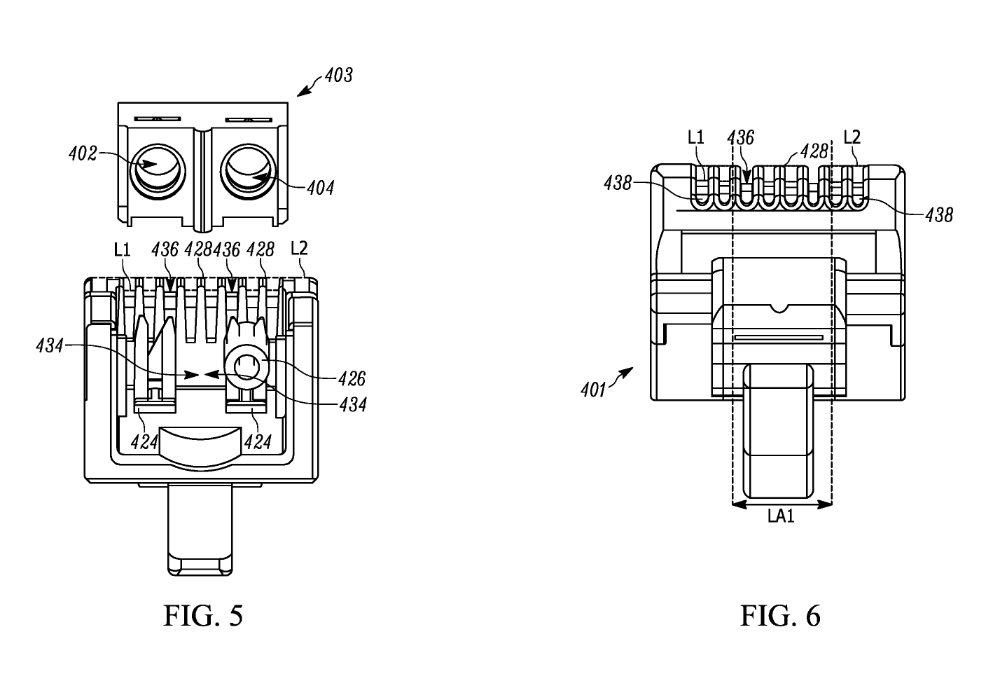

FIG. 5 exemplarily illustrates a partially exploded view of the modular plug 400 of FIG. 4. FIG. 6 exemplarily illustrates an elevation view of the plug of FIG. 4. The stuffer cap 403 includes a pair of channels 402, 404 which are each configured to receive one of a pair of conductor wires 426 of the cable. Each of the channels may extend partially into or wholly through the stuffer cap 403 as desired by the particular configuration and intended application. As shown, the channels 402, 403 extend partially into the stuffer cap 403 so as to provide a positive stop when the conductor wires 426 are inserted into the stuffer cap 403. The stuffer cap 403, when moved into connection with the plug housing 401 in the channel 418, terminates each conductor wire 426 in electrical contact with a respective one of the plug contacts 424. As shown, the stuffer cap 403 is exploded away from the plug housing 401 in order to show the conductor wire 426 terminated to the plug contact 424 with clarity.

In one embodiment, a single-pair of plug contacts 424 is disposed at the mating end 410 of the plug housing 401. Preferably, each contact 424 extends into the channel 418 from the mating end 410 and includes a conductor termination portion 434 disposed in the channel 418 and a jack interface portion 436 disposed at the mating end 410. As shown, the conductor wire 426 is terminated to the conductor termination portion 434 which is configured as an insulation displacement contact, as would be commonly understood by one of skill in the art. Preferably, each conductor termination portion 434 is terminated to one of a pair of conductor wires 426 of a cable. Preferably, the conductor wires 426 are either 16 AWG, 18 AWG, 20 AWG, 22 AWG, 24 AWG, 26 AWG or 28 AWG. However, one of skill in the art will recognize the other wire dimensions may be specified. For example, each conductor wire 426 may be insulated and have an outer diameter greater than 0.040 inches.

Each jack interface portion 436 has components or elements disposed in one of the slots 428. In one embodiment, a number of the plurality of slots 428 is greater than a number of the plug contacts 424 by an even-numbered multiple. For example, the multiple may be 2 times, 4 times, 6 times, etc. In another embodiment, the number of slots 428 may be equal to the number of plug contacts 424. In FIGS. 5 and 6, there are two sets of dashed lines to show two different levels L1, L2 at which the plug housing may be formed with additional material of the same construction. One level L1 is even across the width of the mating end 410 with the jack interface portions 436 and another level L2 is even across the width of the mating end 410 with the end wall 412 exterior surface (i.e., the upper surface of the slots 428 as shown). Either level L1, L2 depending on the intended functionality and standards compliance may be used so that the plug housing 401 will have two slots 428 that will accept the contacts 424. In other embodiments, the plug housing 401 will have no extra lateral extent beyond what is needed for the contacts 424. For example, as shown in FIG. 6, a lateral extent LA1 of the plug housing 401 may be no more than as necessary to dispose the contacts 424 in the necessary slots or to conform to a standard interface, which one of skill in the art will recognize can be any of numerous configurations without departing from this disclosure. In another embodiment, each of the slots 428 that are present, formed, necessary, etc. on the plug housing 401 include a recessed portion 438 disposed therein adjacent the mating end 410. The recessed portion 438 may be characterized as a pocket or volume defined within the slot 428 by a rib, wall, protrusion, formation, etc. in the slot such that the slot 428 has a greater depth from the top surface of the end wall 412 where the recessed portion 438 is disposed compared to where the rib, wall, protrusion, formation, etc. is disposed.

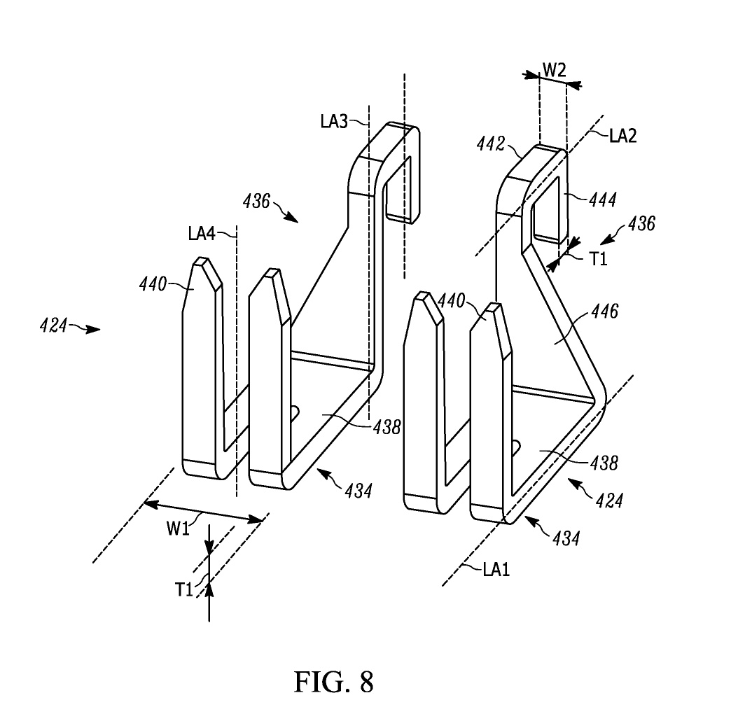

FIG. 8 exemplarily illustrates a perspective view of a pair of contacts in accordance with an embodiment of the present disclosure. As previously mentioned, the contacts 424 have a general “S” shaped configuration that may also be referred to as “swan-like” or “swan neck” in appearance and include a conductor termination portion 434 and a jack interface portion 436. The conductor termination portion 434 may include a base 438 contiguous with one of the side walls 416 (see FIG. 5) and an insulation displacement contact 440 extending from the base 438. In one embodiment, the base 438 may be disposed in a normal or approximately right angle orientation with respect to the insulation displacement contact 440. Preferably, the jack interface portion 436 includes an arm 442 and a tab 444. In one embodiment, the jack contact portion 436 may include a flange 446. The arm 442 may be disposed in a normal orientation with respect to the flange 446 and the tab 444 may be disposed in a normal orientation with respect to the arm 442. A longitudinal axis LA1 of the base 438 may be disposed in a parallel orientation with respect to a longitudinal axis LA2 of the arm 442. A longitudinal axis LA3 of the flange 446 may be disposed in a parallel orientation with respect to a longitudinal axis LA4 of the insulation displacement contact 440 and may be disposed in a parallel orientation with respect to a longitudinal axis LA5 of the tab 444.

An advantage of the contact 424 of this disclosure is that it may be easily formed by simple bending or stamping processes that facilitates selective gold plating on the arm 442 and tab 444 since the raw or unworked side of the contact 424 is on the top or side of the contact 424 that faces away from the plug housing 401 and that interfaces with the jack contact. As a result, the step of electro-polishing commonly necessary for contacts have “rough” edges at the plating site is eliminated. Another advantage of the contact 424 of this disclosure is that it preferably has a thickness T1 in the range of 0.020-0.040 inches which facilitates the ability to carry the current anticipated by the largest contemplated wire size through a single-pair of contacts. Conventional contacts usually have a thickness in the range of 0.010-0.012 inches which requires multiple contacts to carry a current level of no more than 1.5 amps which is a small percentage of the current capacity of the contacts 424 of this disclosure.

Preferably, the flange 446 is disposed contiguous with an interior surface 432 (see FIG. 7) of the end wall 412. In one embodiment, the tab 444 may be disposed the recessed portion 438. When both of the immediately foregoing structural configurations are present the contact 424 is fixed with respect to movement in a direction along the longitudinal axis of the plug housing 401.

The conductor interface portion 434 may have a width W1 that is greater than a width W2 of the jack interface portion 436 which results in the center of the terminated conductor wire 426 being laterally offset from the center of an arm 438 of the jack interface portion 436 (see FIG. 5).

As disclosed in FIG. 3, a second pair of plug contacts 424 may be disposed at the mating end 410 and extend into the channel 418 as taught with respect to any other contacts 424 disclosed herein. In one embodiment, the plug housings 101, 201, 301, 401 and associated plug contacts 424 are each configured to a standard compliant mating interface, such as for example, ANSI/TIA-1096-A, ANSI/TIA-568.5, ISO-8877, ANSI/TIA-1005-A, ANSI/TIA-568.0-D, and ANSI/TIA-862-B.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

Any other undisclosed or incidental details of the construction or composition of the various elements of the disclosed embodiment of the present invention are not believed to be critical to the achievement of the advantages of the present invention, so long as the elements possess the attributes needed for them to perform as disclosed. Certainly, one skilled in the applicable arts would be able to conceive of a wide variety of alternatives, configurations and successful combinations thereof. The selection of these and other details of construction are believed to be well within the ability of one of even rudimental skills in this area, in view of the present disclosure. Illustrative embodiments of the present invention have been described in considerable detail for the purpose of disclosing a practical, operative structure whereby the invention may be practiced advantageously. The designs described herein are intended to be exemplary only. The novel characteristics of the invention may be incorporated in other structural forms without departing from the spirit and scope of the invention. The invention encompasses embodiments both comprising and consisting of the elements described with reference to the illustrative embodiments. Unless otherwise indicated, all ordinary words and terms used herein shall take their customary meaning as defined in The New Shorter Oxford English Dictionary, 1993 edition. All technical terms shall take on their customary meaning as established by the appropriate technical discipline utilized by those normally skilled in that particular art area. All medical terms shall take their meaning as defined by Stedman's Medical Dictionary, 27th edition.

1. A modular plug comprising:
a plug housing including a mating end including an end wall, a cable end and a plurality of side walls extending between the mating end and the cable end to define an open topped channel extending between the end wall that cable end;
a single-pair of plug contacts disposed at the mating end and extending into the channel, where each plug contact includes a conductor termination portion disposed in the channel and a jack interface portion disposed at the mating end;
wherein the conductor interface portion has a width greater than a width of the jack interface portion.

2. The modular plug of claim 1, wherein the end wall includes a plurality of slots defined therein and each jack interface portion is disposed in one of the slots.

3. The modular plug of claim 2, wherein a number of the plurality of slots is greater than a number of the plug contacts by an even-numbered multiple.

4. The modular plug of claim 3, wherein the multiple is selected from a group consisting of 2 times and 4 times.

5. The modular plug of claim 1, wherein each conductor termination portion is terminated to one of a pair of conductor wires of a cable.

6. The modular plug of claim 5, wherein each conductor is selected from the group consisting of 16 AWG, 18 AWG, 20 AWG, 22 AWG, 24 AWG, 26 AWG and 28 AWG.

7. The modular plug of claim 5, wherein each conductor is insulated and has an outer diameter greater than 0.040 inches.

8. The modular plug of claim 1, further comprising a stuffer cap including a pair of channels, wherein each channel is configured to receive one of a pair of conductors of a cable and wherein the stuffer cap terminates each conductor in electrical contact with a respective one of the conductor termination portions when the stuffer cap is connected to the plug housing.

9. The modular plug of claim 8, wherein the stuffer cap is disposed contiguous with the mating end.

10. The modular plug of claim 1, wherein the conductor termination portion includes a base contiguous with one of the side walls and an insulation displacement contact extending from the base.

11. The modular plug of claim 2, wherein the slots include a recessed portion disposed therein adjacent the mating end.

12. The modular plug of claim 12, wherein the jack interface portion includes an arm and a tab, where the tab is disposed the recessed portion.

13. The modular plug of claim 1, further comprising a second pair of plug contacts disposed at the mating end and extending into the channel.

14. The modular plug of claim 1, wherein each plug contact includes the conductor termination portion having a base disposed in a normal orientation with respect to an insulation displacement contact, and the jack contact portion having a flange, an arm disposed in a normal orientation with respect to the flange and a tab disposed in a normal orientation with respect to the arm.

15. The modular plug of claim 14, wherein a longitudinal axis of the base is disposed in a parallel orientation with respect to a longitudinal axis of the arm.

16. The modular plug of claim 15, wherein a longitudinal axis of the flange is disposed in a parallel orientation with respect to a longitudinal axis of the insulation displacement contact and is disposed in a parallel orientation with respect to a longitudinal axis of the tab.

17. The modular plug of claim 14, wherein the flange is disposed contiguous with an interior surface of the end wall.

18. The modular plug of claim 1, wherein the plug housing and plug contacts are configured to define a standard compliant mating interface.

19. The modular plug of claim 18, wherein the standard compliant mating interface is selected from a group consisting of ANSI/TIA-1096-A, ANSI/TIA-568.5, ISO-8877, ANSI/TIA-1005-A, ANSI/TIA-568.0-D, and ANSI/TIA-862-B.

20. The modular plug of claim 8, further comprising a cable holder disposed adjacent the stuffer cap and the cable end.
